(19) United States
(12) Patent Application Publication
(10) Pub. No.: US 2016/0048706 A1
(43) Pub. Date: Feb. 18, 2016

(54) METHOD AND DEVICE FOR SECURE VIEWING ON A SCREEN OF AN ELECTRONIC TERMINAL, AND CORRESPONDING TERMINAL

(71) Applicant: INGENICO GROUP, Paris (FR)

(72) Inventors: Yannick MENET, Chatillon (FR); Christophe AUFFRAY, Rueil Malmaison (FR); Nora DABBOUS, Suresnes (FR)

(21) Appl. No.: 14/776,393

(22) PCT Filed: Mar. 13, 2014
(86) PCT No.: PCT/EP2014/055011

§ 371 Date: Sep. 14, 2015

(30) Foreign Application Priority Data
Mar. 14, 2013 (FR) 1352286

(51) Int. Cl. G06F 21/84; G06F 21/74

(52) U.S. Cl. CPC G06F 21/84; G06F 21/74

(57) ABSTRACT

A method for secure viewing on a screen of an electronic terminal includes determining a mode of operation, secured or open, of the terminal; and modifying the displaying of at least one indicator representing the mode of operation of the terminal. The displaying modification is controlled by at least one secure processor of the terminal and takes into account at least one predetermined action of the user on the terminal and/or of an expiration of at least one predetermined time limit.

### 1. CROSS-REFERENCE TO RELATED APPLICATIONS

This Application is a Section 371 National Stage Application of International Application No. PCT/EP2014/055011, filed Mar. 13, 2014, the content of which is incorporated herein by reference in its entirety, and published as WO 2014/140208 on Sep. 18, 2014, not in English.

### 2. FIELD OF THE INVENTION

The field of the invention is that of electronic terminals. The invention can be applied especially to electronic payment terminals and to electronic terminals having secured payment functions.

In particular, the invention can be applied to the securing of the display on such terminals.

### 3. PRIOR ART

At present, users consider electronic payment terminals to be trusted terminals on which they can enter sensitive data such as a confidential code or user data.

The development of the markets for these terminals is tending to broaden their use by enabling them to support not only the payment application but also widgets, business applications, vertical applications, etc. Here below in the document, the terminal is considered to be working in “open” mode when software applications other than those strictly needed for security reasons are executed on it.

Thus, in open mode, the secured payment terminal shares the terminal screen with applications.

It is therefore necessary to be able to continue to reassure the user about the security of the payment actions while alerting him to the fact that the security of the other applications offered by his terminal are not guaranteed. Indeed, in open mode, software applications other than those strictly related to security are liable to imperil the security of the terminal and betray the users' trust.

At present, there are several techniques for informing the user about the mode (whether secured or open) in which the terminal is operating.

For example, the patent document FR2914457 describes the use of a banner indicating the mode of operation of the terminal that can switch between different positions on the screen. The shifting of the banner on the screen can be defined randomly or it can be activated by the insertion of a payment means.

One drawback of this prior-art technique lies in the absence of flexibility or adaptability of the banner which, apart from its possible movements, remains a predefined element that is permanently displayed on the screen.

### 4. SUMMARY OF THE INVENTION

The invention pertains to a method of secured viewing on a screen of an electronic terminal. According to the different embodiments of the invention, the method comprises the following steps:

a step for determining the mode of operation, whether secured or open, of the terminal, the step for determining the mode of operation being controlled by at least one secured processor of the terminal;

a step for displaying at least one default indicator representing the determined mode of operation of the terminal, the step for displaying being controlled by at least one secured processor of the terminal;

a step for modifying the display of the indicator, the step for modifying the display being controlled by at least one secured processor of the terminal and taking account of at least one predetermined action of the user on the terminal and/or an expiry of at least one predetermined timeout.

Thus, the invention relies on a novel and inventive approach to secured viewing of on a screen of an electronic terminal, with at least one indicator being displayed on the screen under the control of a secured processor of the terminal, at least one indicator enabling the user to know if he is in secured mode or not, the parameters of display of this indicator depending chiefly on the user's actions.

Indeed, future electronic terminals, and more particularly electronic terminals having payment functions, could work in secured mode, for example for payment applications, and in open mode, for example for customer applications. It is therefore important not only to inform the user of the mode, whether secured or unsecured, in which the terminal is situated but also to explicitly discourage the user from entering sensitive data in open mode or to reassure him when he wishes to enter sensitive data in secured mode.

To this end, in the solution according to the different embodiments of the invention, firstly a visual indicator is displayed representing the mode of operation of the terminal and, secondly, at least one action on the part of the user is taken into account so as to modify the parameters of display of this indicator.

Thus, in secured mode, the display of the indicator allows to reassure the user when he is entering a confidential code for example whereas, in open mode, the display of the indicator makes the user aware that the terminal is working in open mode.

Besides, the display of the indicator, also called a visual warning, is always controlled by a secured processor which determines whether the mode of operation is secured or open. In this way, the display of the indicator as well as the modifications of the display cannot be corrupted or prevented by a malicious application.

According to the invention, the visual warning is always present (even if it may be present intermittently) and its visibility (size, color, position, luminosity, intermittence) depends on the user's actions on the terminal. Thus, when there are not user interactions, the indicator has low visibility so as not to disturb the user but remains visible enough to capture the user's attention and inform him of the state of the terminal. If several interactions take place one after the other (in a short period of time for example), the visual warning becomes increasingly visible or else the characteristics of size, color, position, luminosity, intermittence of the indicator can change in order to warn the user.

Thus, an indicator can for example be displayed in a transparent display or see-through display on the screen over the application or applications being displayed on the screen of the terminal, very discreetly so as not to disturb the user in his usual use of the terminal.

Then, when the user performs an action on the terminal, the display of the indicator is modified so that it becomes either more present or less present on the screen.

For example, this modification of the display can be activated by an entry made by the user on the physical or virtual keyboard of the terminal.

In this case, the modification of the display is aimed chiefly at making the indicator more present on the screen so as to more distinctly make the user aware of the fact that the terminal is working in open mode or to more distinctly reassure the user when he enters a confidential code in secured mode.

In addition, the display of the indicator can be modified gradually. For example, when the terminal is in open mode and when the user makes a first entry on the keyboard, a first modification of the indicator display can be made to warn the user about the risk of entering sensitive data in open mode. Then, if the user makes a second entry, then a second modification of the indicator display can be made to make the indicator even more visible and so on and so forth. However, if, after the first entry, the user stops interacting with the terminal, then the display of the indicator can return to the default display since there is no longer any risk of sensitive data being entered. For example, the return to the default display can be done following the expiry of a predetermined timeout during which no entry has been made by the user.

Then, if several successive modifications of the display have led to a display with a very strong presence on the screen, this invention also provides, according to this embodiment, the display of the indicator to return to the default display. This will happen for example when the user no longer interacts with the terminal within a determined timeout or else when the risk related to the open mode no longer exists, etc.

According to one particular aspect of the invention, the step for modifying the display takes account of at least one piece of information representing a predetermined position for the indicator.

Thus, the method according to this embodiment of the invention makes it possible to take account of a piece of information representing an optimal position of the indicator before displaying this indicator.

For example, this optimal position takes account of a position of a window representing, on the screen, entries on the physical keyboard of the terminal or else a history of entries made in the case of a virtual keyboard.

Or else, this optimal position corresponds to a predefined position on the screen, so as to avoid inconveniencing the user independently of the application or applications being displayed on the screen.

According to one embodiment of the invention, the step for modifying the display consists of a modification of at least one parameter of viewing of the indicator belonging to the group comprising:

intensity;

luminosity;

transparency;

color;

size;

shape;

the position on the screen;

the language of the text;

a combination of at least two of the parameters of the group.

According to this embodiment of the invention, the display of the indicator is modified by means of one or more parameters of display of the indicator.

For example, since the indicator is already displayed transparently, the modification of the display can consist of a reduction/increase of the transparency or an increase/reduction of the luminosity or of the intensity of the display, or else a modification of the color of the indicator. In this way, the indicator appears more or less distinctly on the screen so as to modify the user's perception of it.

This embodiment of the invention also provides for the modifying, in combination possibly with the previously mentioned modifications, of the size or shape of the indicator, again in order to make it more or less visible to the user.

For example, the indicator can appear ever bigger on the screen when there is a risk of sensitive data being entered in open mode.

Similarly, according to this embodiment of the invention, the position of the indicator on the screen can be modified. The mobility of the position of the indicator on the screen makes it possible to increase its visibility to the user by drawing his attention to a “moving” display as well to reduce disturbance for the user when he makes an entry. The position of the indicator on the screen can be modified for example randomly. The position of the indicator on the screen can be modified also in a controlled manner by the processor depending on the content displayed, either to increase the visibility of the indicator on the screen or in such a way as not to inconvenience a user while he is making an entry.

For example, the step for modifying the display implements a transparent display of an indicator in the form of at least one graphic object.

Thus, according to this embodiment of the invention, the indicator takes the form of a graphic object such as an icon, displayed transparently on the application or applications already displayed on the screen. In this way, because of the transparency, the display of the indicator does not disturb the user in his viewing of the screen. At the same time, he is informed about the mode of operation of the terminal, i.e. whether it is secured or not secured.

This icon can be interpreted by the user as a warning in open mode, for example in the form of a “no entry sign” or a “stop” sign or as permission or an encouragement in secured mode, for example in the form of a “smiley” or a “green light”.

According to one particular aspect of the invention, the transparent display of the indicator is done at regular intervals.

Thus, according to this embodiment of the invention, the indicator is not displayed permanently but in a “flashing” form so as to increase its visibility to the user.

For example, an action by a user on the terminal belongs to the group comprising:

an entry on a physical keyboard or keypad;

an entry on a touchpad;

an entry via a biometric sensor;

a voice entry.

Thus, the user's actions activate a display of the indicator or modify the current display of the indicator are chiefly entries on a keypad, entries of this type being particularly risky in open mode if the user is being deceitfully requested to enter sensitive data (because, normally, in open mode a user should not have to enter sensitive data). In addition, it should also be possible for the user to be reassured when he enters his confidential data in secured mode.

The biometric entries (fingerprints, iris scans, etc.) as well as a voice entry can also activate a display of the indicator or a modification of the current display of the indicator.

According to one particular characteristic of the invention, the step for modifying the display also takes account of at least one parameter for displaying the background image of the terminal.

According to this embodiment of the invention, one or more parameters of display of the indicator are modified so that the indicator remains visible relative to the background image.

For example, if the background image is a dark color, the color of the indicator will be modified so that it remains visible.

The invention also relates to a device for secured viewing on a screen of an electronic terminal. According to the invention, the device is capable of implementing the steps of the method described here above and comprises the following means:

means for determining (for example in the form of a determining module) the mode of operation, whether secured or open, of the terminal, controlled by at least one secured processor of the terminal;

means for displaying and modifying the display (for example in the form of a display and display modifying module) of at least one indicator representing the mode of operation of the terminal, the means for displaying and modifying the display being controlled by at least one secured processor of the terminal and taking account of at least one predetermined action of the user on the terminal and/or an expiry of at least one predetermined timeout.

The invention also relates to an electronic terminal comprising a viewing device as described here above.

### 5. LIST OF FIGURES

Other features and advantages of the invention shall appear more clearly from the following description of a particular embodiment, given by way of a simple, illustratory and non-exhaustive example, and from the appended figures, of which:

FIG. 1 illustrate the main steps of the method of viewing according to one embodiment of the invention;

FIGS. 2a to 2c illustrate examples of implementation of the invention according to different embodiments, when the terminal works in secured mode;

FIGS. 3a to 3c illustrate examples of implementation of the invention according to different embodiments, when the terminal works in open mode;

FIG. 4 presents an example of a viewing device according to one embodiment of the invention.

### 6. DESCRIPTION OF ONE EMBODIMENT OF THE INVENTION

### 6.1 General Principle

The general principle of the invention relies on the updating of the display, on an electronic terminal screen, of an indicator representing the mode of operation, whether secured or open, of the terminal, the updating depending chiefly on the users' actions.

Thus, certain display parameters of the indicator, also called a visual warning, are modified according to the users' actions on the terminal, such as for example entries made on a physical or virtual keypad, or according to the expiry of a predetermined timeout, such as for example a certain period of time when there is no interaction on the part of the user.

In this way, the invention in its different embodiments enables the display of the visual warning to be adapted as efficiently as possible to the use of this terminal, while at the same time alerting the user in the event of risks of sensitive data being entered in open mode for example, or reassuring the user in secured mode.

### 6.2 Description of One Embodiment

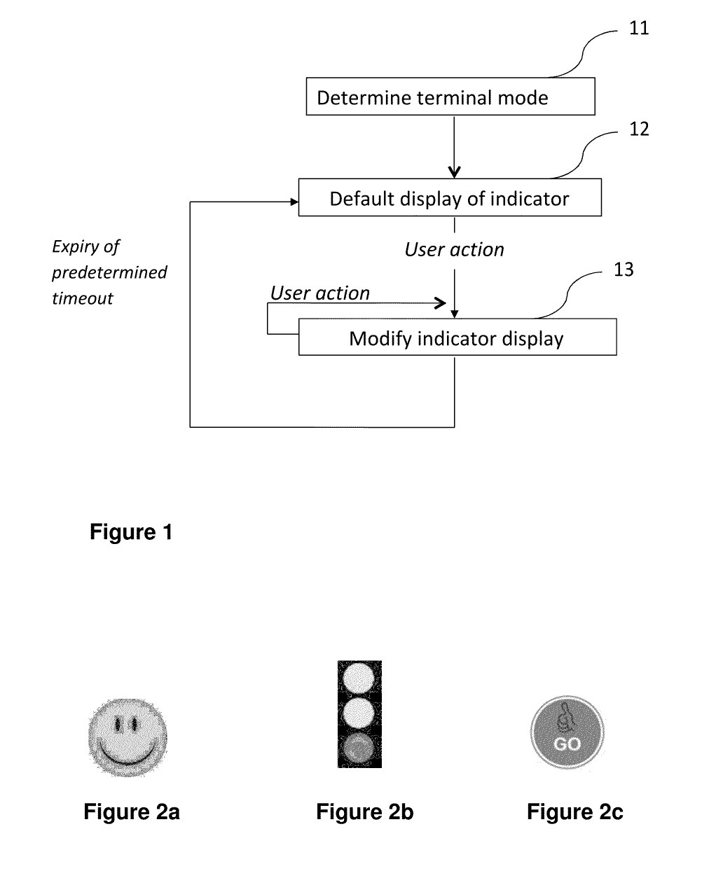

Referring now to FIG. 1, we present the main steps of the method of viewing according to one particular embodiment of the invention.

A first step 11 is used to determine the mode of operation, whether secured or open, of the terminal. This determining is implemented by a secured processor of the terminal. The architecture of the terminal can be a single-processor architecture and, in this case, the single processor is secured, or it can be a multi-processor architecture and in this case there is at least one processor that is secured and this is this processor that determines the mode of operation of the screen.

The display of an indicator representing the mode of operation of the terminal can therefore be implemented, according to a step 12, once this mode of operation is determined. This display, as well as a subsequent modification of the display, is also controlled by the secured processor so as to prevent a malicious application from blocking or altering this display.

Thus, according to this particular embodiment of the invention, a visual warning is displayed in the form of an icon in a transparent or see-through display over the application or applications being displayed on the screen of the terminal. This display can be considered to be a default mode of display of the indicator.

For example, this icon takes the form of a smiley (FIG. 2a), a green light (FIG. 2b) or again an icon as illustrated in FIG. 2c when the terminal works in secured mode.

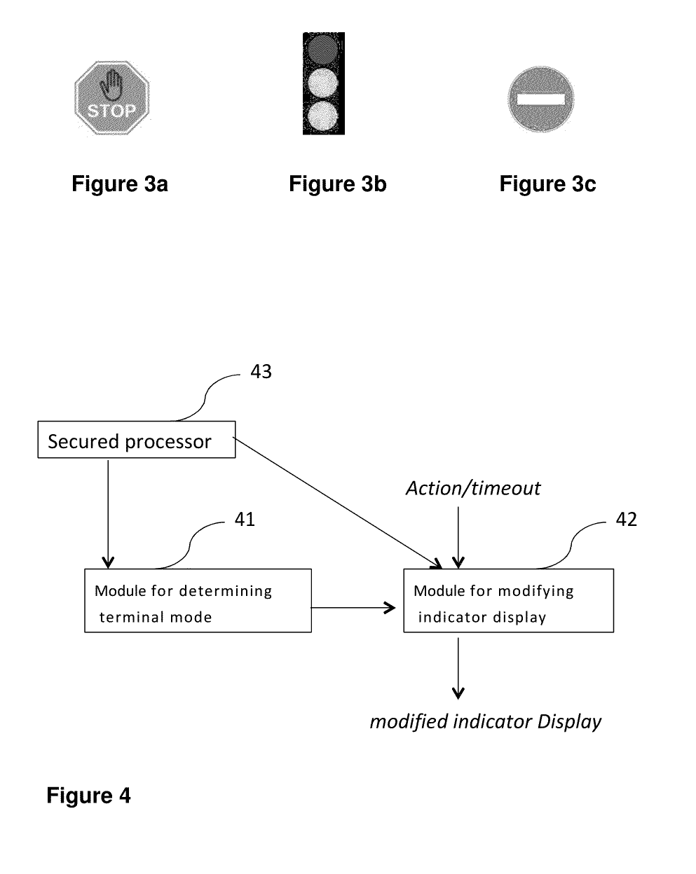

When the terminal works in open mode, this icon takes the form for example of a “stop” sign (FIG. 3a), a red light (FIG. 3b) or again a no-entry sign (FIG. 3c).

In this embodiment of the invention, the default transparent display of the icon can be intermittent so as to arouse the user's interest.

This default display can also be implemented in a mobile manner at positions that change, for example randomly, at regular intervals.

In addition, the default display can be different according to the mode of operation of the terminal. Indeed, in secured mode, the goal is to reassure the user without disturbing him in his use of the terminal. In this case, the display could be fixed and permanent. However, it could also be mobile depending on the modifications of display of an application in progress, so as not to inconvenience the user, for example during an entry. However, in the open mode, since the goal is to warn the user, the default display could be intermittent and moving. These examples of default display are purely illustratory and not exhaustive. Several combinations of the different display parameters of the icon can be envisaged, according to the needs of the users, the applications already displayed on the terminal, etc.

Then, a step 13 for modifying the display of the indicator is implemented, following an action by the user.

For example, a user action such as an entry on a keypad, whether physical or virtual, an entry via a biometrical sensor or a voice entry activates a modification of display of the visual warning, according to this embodiment of the invention.

For example, according to a first variant of this embodiment, the terminal is considered to be in open mode, and an icon that warns the user is displayed transparently on the application A. This application A requires for example an entry by the user, such as the validation of a choice. This validation by the user causes the display of the indicator to be modified so as to remind the user more distinctly that the terminal is working in open mode. A step 13 for modifying the display of the indicator is therefore implemented. For example, the size of the icon increases so as to be more visible, or else its intensity increases or again its transparency diminishes or the warning flashes. These different parameters of display can of course be modified simultaneously. Other parameters such as for example the luminosity, color or again the position of the icon can also be modified. These parameters of display are not exhaustive and are cited by way of illustration.

In this first variant, after the user has validated his choice, he is considered to be no longer interacting with the terminal for a period greater than a predetermined timeout, equal for example a few seconds. In this case, according to this first variant of this embodiment of the invention, a step 12 for returning to the default display of the indicator can be implemented, upon expiry of the predetermined timeout. Indeed, when the user has stopped interacting for several seconds after a first entry ,there no longer exists any risk that the user is in the process of entering sensitive data such as a confidential code.

In a second variant, the terminal is still considered to be in open mode and, in the step 12 an icon warning the user is displayed transparently over an application B. This variant envisages the case where this application B is malicious and is asking the user to enter sensitive data, such as for example bank data and especially a confidential code. If the user starts entering this code, the first entry causes the indicator display to be modified through a display-modifying step 13 so as to remind the user more distinctly that the terminal is working in open mode. As in the first variant, one or more parameters such as size, intensity, transparency, luminosity, color or again the position of the icon can be modified. Following a second entry by the user, if, despite the visual warning, he continues to enter sensitive data, a step 13 for modifying the display of the indicator is again applied to again modify one or more parameters of display of the icon, the goal being still that of warning the user that the terminal is in open mode. Depending on the user's behavior, several successive steps for modifying the display of the icon to make it more visible are therefore implemented, following actions such as for example entries by the user. Upon expiry of a predetermined timeout period during which the user has not interacted with the terminal, the display returns to the default state.

According to a third variant, the terminal is considered this time to be in secured mode (step 11) and the icon displayed transparently (step 12) reassures the user who is about to enter for example sensitive data such as a confidential code. At each entry by the user, a step 13 for modifying the display of the indicator can be implemented, for example to modify the position of the indicator so as not to disturb the user while at the same time reassuring him about the fact that the terminal is working effectively in secured mode. In this variant, it is not necessary for example to increase the intensity or the luminosity or again the size of the indicator, the aim being to reassure the user without hampering his use of the terminal. However, a change in position of the indicator can reinforce his sense of security without disturbing him in the entry. Naturally, other parameters of display of the indicator can be modified.

According to this embodiment of the invention, the step 12 for displaying the indicator and the step 13 for modifying the indicator display can also take account of a piece of information representing a predetermined position for the indicator for example so as to take account of the display or displays already in progress on the screen. Thus, the secured processor has one or more pieces of information available on the application or applications being displayed, especially for example information corresponding to parameters of display such as the position on the screen. In this way, the icon as well as its display parameters are chosen so as to ensure optimal visibility of the indicator, according to the background image and the application or applications being displayed.

For example, in the case of a touchpad enabling entries by the user, the position of the indicator can be determined as a function of a history of entries already made by the user. In another case, if an application occupies a lower part of the screen, the method of the invention makes it possible to choose an icon to be displayed in transparency for example on the upper part of the screen.

In addition, the steps 12 for displaying the indicator and 13 for modifying the indicator display can also take account of information related to the background image. Thus, for example, if the background image is dark-colored, the method of the invention chooses a light-colored icon.

### 6.3 Example of a Viewing Device

FIG. 4 presents a simplified structure of a viewing device implementing the method of viewing according to the different embodiments of the invention (for example the particular embodiment described here above with reference to FIG. 1). This device comprises means 41 for determining the mode of operation, whether secured or open, of the terminal (for example in the form of a module for determining the mode of operation) and means 42 for displaying and modifying the display of at least one indicator representing the mode of operation of the terminal (for example in the form of a module for displaying and for modifying display). The means 41 for determining the mode of operation and the means 42 for displaying and modifying display are controlled by at least one secured processor 43 of the terminal. These means 42 for displaying and modifying display take account of at least one predetermined action of the user on the terminal and/or the expiry of at least one predetermined timeout.

This FIG. 4 illustrates only one particular way among several possible ways to obtain the different embodiments of the invention described here above.

For example, the module 41 for determining the mode of operation and the module 42 for displaying and modifying the display can form part of the secured processor.

At least one embodiment of the invention provides a technique for securing the display on a screen of an electronic terminal, this technique being universal and efficient in every case of use of the terminal.

At least one embodiment of the invention provides a technique for securing the display on a screen of an electronic terminal that is easy to implement and costs little, while offering optimal ergonomy to the user.

Although the present disclosure has been described with reference to one or more examples, workers skilled in the art will recognize that changes may be made in form and detail without departing from the scope of the disclosure and/or the appended claims.

1. Method of secured viewing on a screen of an electronic terminal, characterized in that it comprises the following steps:
a step (11) for determining the mode of operation, whether secured or open, of said terminal;
a step (12) for displaying at least one default indicator representing said determined mode of operation of said terminal;
a step (13) for modifying the display of said indicator, said step for modifying display taking account of at least one predetermined action of said user on said terminal and/or an expiry of at least one predetermined timeout,
said steps for determining the mode of operation (11), displaying (12) and modifying (13) display being controlled by at least one secured processor of said terminal.

2. Method of viewing according to claim 1, characterized in that said step for modifying display takes account of at least one piece of information representing a predetermined position for said indicator.

3. Method of viewing according to claim 1, characterized in that said step for modifying display consists of a modification of at least one parameter of viewing of said indicator belonging to the group comprising:
intensity;
luminosity;
transparency;
color;
size;
shape;
the position on the screen;
the language of the text;
a combination of at least two of the parameters of said group.

4. Method of viewing according to claim 1, characterized in that said step for modifying display implements a transparent display of an indicator in the form of at least one graphic object.

5. Method of viewing according to claim 4, characterized in that said transparent display of said indicator is done at regular intervals.

6. Method of viewing according to claim 1, characterized in that at least one action by said user on said terminal belongs to the group comprising:
an entry on a physical keypad;
an entry on a touch pad;
an entry via a biometric sensor;
a voice entry.

7. Method of viewing according to claim 1, characterized in that said step for modifying display also takes account of at least one parameter of display of the background image of said terminal.

8. Device for secured viewing on a screen of an electronic terminal, characterized in that it comprises the following means:
means (41) for determining the mode of operation, whether secured or open, of said terminal;
means (42) for displaying and modifying the display of at least one indicator representing said mode of operation of said terminal, said means for displaying and modifying display taking account of at least one predetermined action by said user on said terminal and/or an expiry of at least one predetermined timeout,
said means for determining the mode of operation and said means for displaying and modifying display being controlled by at least one secured processor (43) of said terminal.

9. Electronic terminal characterized in that it comprises a viewing device according to claim 8.
